(19) United States
(12) Patent Application Publication
(10) Pub. No.: US 2005/0130529 A1
(43) Pub. Date: Jun. 16, 2005

(54) Photocatalytic fabric product and a manufacturing method thereof

(76) Inventors: Jung-Shen Lien, Sansia Township (TW); Hung-En Chen, Taipei (TW); Po-Hsiung Huang, Taipei City (TW); Hsin-Chieh Chen, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/838,265

(22) Filed: May 5, 2004

(30) Foreign Application Priority Data
Dec. 11, 2003 (TW) 092131599

(51) Int. Cl. B32B 27/12; B32B 27/04

(52) U.S. Cl. 442/149

(57) ABSTRACT

A photocatalytic fabric products and a manufacturing method thereof uses a plasma polymerization process and a sputtering process under the vacuum environment. The protective layer is deposited on the surface of the fabric product. Then, it uses the sputtering process to excite the photocatalytic material. The atom of the photocatalytic material is excited and forms the photocatalytic thin-film on the surface of the fabric substrate. The thin-film has hydrophilic and anti-bacterial properties thereto can enhance the hydrophilic and anti-bacterial functions in the fabric product. Further, it can widely apply to the medical, upholstery, and other fiber-related field.

### FIELD OF THE INVENTION

The present invention relates to a photocatalytic fabric product and a manufacturing method thereof. More particularly, the invention uses a plasma polymerization process and a sputtering process to make the protective layer and the photocatalytic thin-film deposit on the surface of the fabric product. Further, it can enhance the hydrophilic and anti-bacterial functions in the fabric products.

### BACKGROUND OF THE INVENTION

Life quality is gradually demanded nowadays, and human beings require more comfortable and healthier environment. Therefore, the anti-bacterial fabric product is one of the essential parts in our daily life. It is commonly to see that the anti-bacterial agent is used in the anti-bacterial fiber process, such as the inorganic anti-bacterial agent comprising zeolite, TiO₂, metal, silicate, and phosphate, the organic anti-bacterial agent comprising quaternary ammonium compounds and guanidine compounds, and natural extracts comprising chitosan, and sodium alginate. More, it is often to be used with the following manufacturing processes: (1) anti-bacterial reeling-off process. (2) coating process. (3) impregnated process. The above manufacturing methods commonly cause problems in the environmental and water pollutions. These, therefore, increase the manufacturing and society costs.

U.S. Pat. No. 6,387,844, U.S. Pat. No. 6,228,480, U.S. Pat. No. 6,108,476, U.S. Pat. No. 5,919,726, and U.S. Pat. Nos. 5,707,915 disclose a coating method. However, the shortages in the aforementioned patents are photocatalytic waste, non-uniform coating, poor photocatalytic efficiency, easily yellowing on woven surface, and resin solvent pollution, etc. Further, U.S. Pat. No. 6,066,359 and Jap. Patent 10-216210 disclose an impregnated method. The shortages of the aforementioned patents are the unstable uniformity and the water pollution. It, therefore, requires specified dispersing agent to deal with the uniformity problem.

According to the mentioned problems, the present invention is to provide a novel photocatalytic fabric product and a manufacturing method thereof to overcome the traditional shortages in the impregnated method and the coating method. The present inventors put many efforts on this invention based on long-term experiences in product research, development, and marketing. Finally, the present invention is presented for overcoming the above problems.

### SUMMARY OF THE INVENTION

It is an object of the present invention to provide a photocatalytic fabric product and a manufacturing method thereof. It uses a plasma polymerization process to form a protective layer with the thickness at less than 1 μm on the surface of the fabric product. More, it uses a sputtering process to form a photocatalytic film with the thickness at less than 100 nm on the protective layer. By using the protective layer, the photocatalytic thin-film can be easily deposited instead of easily peeled-off. Also, the fabric product is not easily to be decomposed in the sputtering process. The present invention can provide the hydrophilic and anti-bacterial properties for the fabric product.

It is another object of the present invention to provide a photocatalytic fabric product and a manufacturing method thereof. It uses the plasma process to clean and activate the said fabric product. This can make the functional group on the surface of the fabric product be activated thereto enhance the adhesion ability for the protective layer.

It is still another object of the present invention to provide a photocatalytic fabric_product and a manufacturing method thereof. The whole process of the present invention is under the vacuum environment. More, it uses an inert gas to make the said protective and the said photocatalytic thin-film efficiently adhere on the fabric product.

It is still another object of the present invention to provide a photocatalytic fabric_product and a manufacturing method thereof. The transparency of the photocatalytic thin-film produced by using the present invention is relatively high, and it does not have any effect on the color of the fabric product.

It is yet object of the present invention to provide a photocatalytic fabric product and a manufacturing method thereof. It uses the sputtering manufacturing process and the plasma polymerization process under the vacuum environment to implement the present invention. Therefore, it should not cause any environmental problems.

In order to achieve the aforementioned advantages and the effects, the present invention relates to a photocatalytic fabric product and a manufacturing method thereof. It uses a plasma polymerization process and a sputtering process under the vacuum environment. First, a protective layer is deposited on the surface of the fabric product. Further, it uses the magnetic plasma process to excite the photocatalytic material. The excited atom of the photocatalytic material can form a photocatalytic thin-film on the surface of the fabric product with hydrophilic and anti-bacterial properties. Besides, because of the structure of the fabric product, the photocatalytic thin-film can spread over a wider area. This therefore can enhance hydrophilic and anti-bacterial properties of the fabric product. Further, it can widely apply to the medical, upholstery, and other fiber-related fields.

### BRIEF DESCRIPTION OF DRAWINGS

The accompanying drawing is included to provide a further understanding of the invention, and is incorporated in and constitutes a part of this specification. The drawing illustrates an embodiment of the invention and, together with the description, serves to explain the principles of the invention. In the drawing,

FIG. 1 is one of the preferred embodiments in the present invention showing the flow chart for the photocatalytic fabric product;

FIG. 2 is one of the preferred embodiments in the present invention; and

FIG. 3 is one of the preferred embodiments showing the photocatalytic fabric product.

### DETAILED DESCRIPTION OF THE PREFERRED EMBODIMENTS

There are just some of the features and advantages of the present invention. Many others will apparent by reference to the detailed description of the invention taken in combination with the accompanying drawings.

The present invention is to solve the shortages of the coating method and the impregnated method as shown in the traditional uses. Further, it uses a plasma polymerization process and a sputtering process under the vacuum environment to achieve non-polluting, hydrophilic and anti-bacterial functions thereto make the protective layer and a photocatalytic thin-film meet the nanometer standard.

Plasma polymerization method is a process that uses an electrical field to excite atoms, molecules, ions, electrons, and gas monomers to form a gas-like condition. Then, monomers are bombarded by the aforementioned particles to form functional group monomers with free radicals. By condensation polymerization reaction, it forms the polymer.

The photocatalytic effect is applied to the bondgap character of the semiconductor material. It uses the semiconductor with adequate bondgap range (such as TiO₂ with a Bondgap at 3.2 eV) in the present invention. While the semiconductor material exposed to the light with specific wavelength, it can induce hydrophilic, anti-bacterial, and deodorized properties thereto enhance hydrophilic, anti-bacterial, and deodorized functions in the fiber-related product.

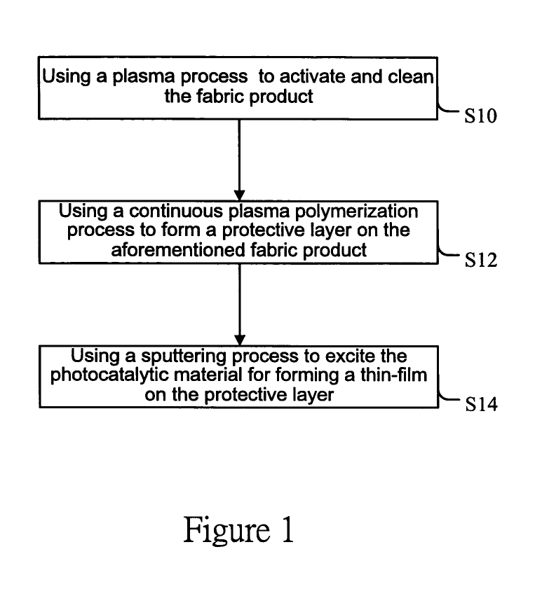

First, please referring to FIG. 1, it is one of the preferred embodiments in the present invention showing the flow chart for the photocatalytic fabric product. As shown in FIG. 1, the present invention relates to the manufacturing method for the photocatalytic fabric product. The aforementioned method is performed in the vacuum environment, mainly comprises the following steps:
Step S10, using a plasma process to activate and clean the fabric product;
Step S12, using a continuous plasma polymerization process to form a protective layer on the aforementioned fabric product; and
Step S14, using a sputtering process to excite the photocatalytic material for forming a thin-film on the protective layer.

In the step S10, the gas-phase plasma has a lower temperature, therefore it can improve the surface property and change the polarity of the material while performing the surface process to the material and enhance the adhesive ability with other material. Further, the present invention uses N₂ to process under the vacuum environment at 10¹˜10⁻⁴ torr. In the step S10, it requires oxygen and Ar in the plasma process. In step S12, it requires fluoride or silicide monomer gas in the plasma polymerization process. In step S14, it requires oxygen and Ar in the sputtering process. The flow rate of the aforementioned N₂, oxygen, and Ar is controlled at 20˜100 sccm(standard cubic centimeter Per minute, cm3/min).

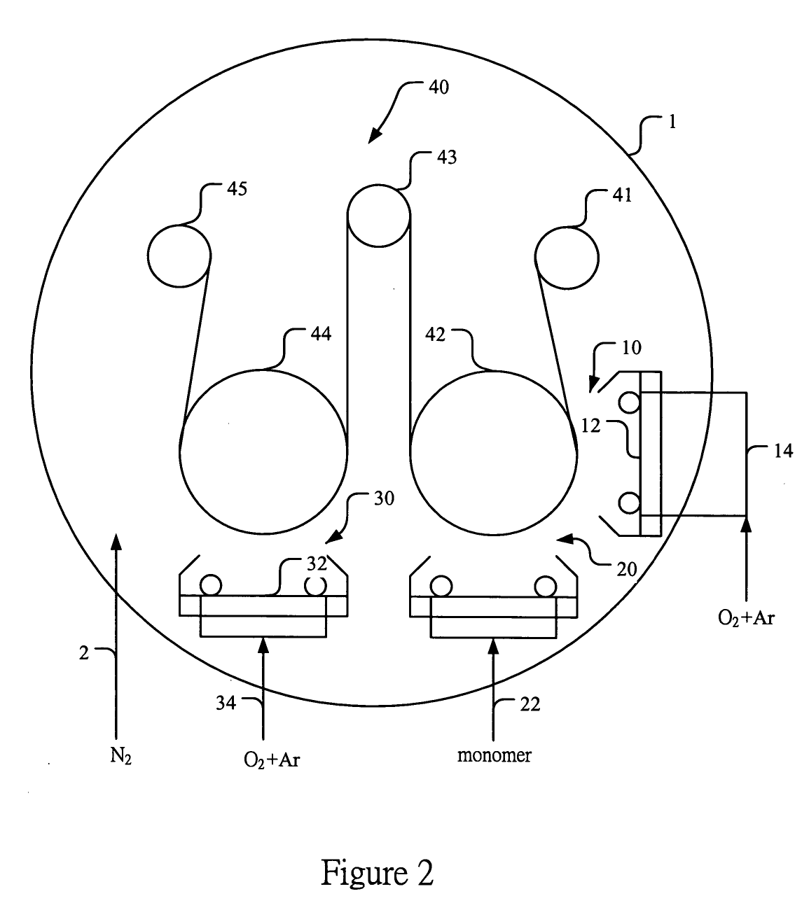

The below is another example. Please referring to FIG. 2, it is one of the preferred embodiments in the present invention. As shown in FIG. 2, the present invention uses N₂ 2 in the vacuum chamber 1. Further, it comprises a preparation area of the fabric product 40; two rollers 41 and 45 for rolling and releasing; a roller 43 for adjusting tension of the fabric product; the cooling circulation water inside the two rollers 42 and 44 for reducing the concentrated heat on the surface of the fabric product. While the surface of the fabric product has many particles and a rough surface, it can affect the sequent plasma polymerization and sputtering photocatalytic thin-film effects. In plasma processing area 10, there is inert gas 14 with adequate pressure at less than 10¹ torr passing through the plasma panel 12 for substrate 42 cleaning and activation. By using the large molecule of the inert gas to bombard fiber surface structure, it can clean the fiber surface and activate the functional group thereto strengthen the adhesive ability of the fiber surface.

In plasma polymerization area 20, the material (such as fluorosilane related gas monomers)22 of the protective layer gets into the vacuum chamber 1, and mixes with the inert gas comprising He, Ne, and Ar at an adequate chamber pressure 10¹˜10⁻³ torr. Then, the voltage is adjusted for forming the polymer monomer thin-film on the surface of the fabric product. The thin-film is uniform and continuous, and the thickness of thin-film is less than 1 mm.

In sputtering area 30, there is a photocatalytic material 32 with above 99% of purity, comprises different kinds of crystal structures (such as anatase and rutile phases of TiO₂, ZnO, SiOx) through sintering, molding, and shaping processes under over 1000° C. temperature for providing essential photocatalytic properties in the present invention, such as hydrophilic, anti-bacterial, deodorized, hardness, heat resisting, and chemical resisting properties. The sputtering method can apply a voltage to make the photocatalytic material 32 be bombarded by the inert gas 34, such as Ar and O, under the chamber pressure lower than 10⁻² torr. This can make the semiconductor moleculize and follow the magnetic direction to deposit on the fabric surface under the influence of magnetic field.

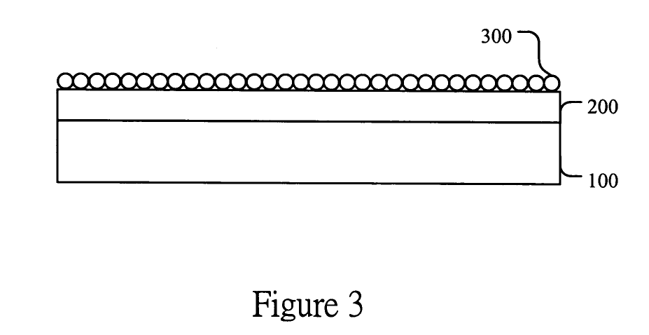

Please referring to FIG. 3, it is one of the preferred embodiments in the present invention showing the photocatalytic fabric product. As shown in FIG. 3, the photocatalytic fabric product mainly comprises a fabric product 100; a protective layer 200 positioning on the fabric product 100; and a photocatalytic thin-film 300 positioning on the protective layer 200.

The protective layer 200 is chosen one of the materials from silicate, fluoride, fluorosilicate, fluorosilane, or SiO₂. The photocatalytic thin-film 300 is chosen one of the materials from TiO₂, TiO, ZnO, MgO, Al₂O₃, or SiO₂. The thickness of the protective layer 200 is less than 1 μm. The thickness of the photocatalytic thin film 300 is less than 100 nm. The photocatalytic thin-film 300 decreases the contact angle of water drop to less than 10°.

The environmental concept is enhanced nowadays, and the clean and green-related techniques are main streams of the manufacturing process. The present invention provides a new manufacturing technique, which can process the first stage of plasma polymerization through the plasma cleaning and activation on the fabric product. The purposes are: (1) making the surface of the fabric product flatten. (2) protective layer can be formed on the surface for avoiding decomposition on the fabric product in the photocatalytic process. The second stage is using sputtering method for exciting the photocatalytic material. The photocatalytic polymer is deposited on the polymer thin-film of the fabric product. This can form a fabric product with a double-layered composition structure. The manufacturing environment is under the vacuum condition. The sputtering method can make the photocatalytic thin-film deposit on the fiber surface, and the process is simple and efficient thereto avoid the pollution problems causing from chemical coating, resin coating, and impregnation.

The present invention is to manufacture the photocatalytic fabric product. It uses a continuous plasma polymerization process and a sputtering technique to deposit the polymer thin-film and the photocatalytic thin-film on the surface of the fabric product. The main character comprises: (1) a continuous process can implement a plasma polymerization process and a sputtering process in once under vacuum condition. (2) different monomer gas can be used in the plasma polymerization further to implement different types of polymer thin-films. (3) using a sputtering molecule to enhance the deposition speed of the photocatalytic molecule. (4) different gas environments can implement different types pf photocatalytic semiconductor thin-films. Besides, the present invention can widely apply to different kinds of fiber-related products comprising nylon, polyester, cotton, linen, non-woven, and polycarbonate. Low temperature, continuous, atmosphere systems can apply to the thin film in different kinds of materials, and can achieve hydrophilic, anti-bacterial, and deodorized functions for the different kinds of fabric products. Therefore, the present invention can apply photocatalytic material to the fiber-related product, and efficiently extend to hydrophilic, anti-bacterial, and deodorized applications. More particularly, it can enhance the quality of the product thereto overcome the problems causing from manufacture. This can create more benefits and keeps the product competitive.

The following description is the advantages of the present invention. The plasma polymerization thin-film of present invention provides a protective layer on the surface of the fabric product. More, the photocatalytic polymer easily deposits and adheres. Further, the photocatalytic effect cannot cause decomposition on the fabric product. The fabric product of the present invention is cleaned and activated by the plasma process to make the functional group of fiber surface be activated thereto enhance the adhesive ability of the plasma polymerization thin-film.

The present invention uses the sputtering process with the photocatalytic material under the vacuum condition and the inert gas to deposit the photocatalytic thin-film on the surface of the fabric product. This process is indeed with efficiency.

The transparency of the photocatalytic thin-film manufactured by the present invention is relatively high and it will not affect the color presentation of the fabric product.

The surface of the photocatalytic thin-film manufactured by the present invention is composed of nanometer particles. Therefore, it can enhance the photocatalytic area thereto increase the photocatalytic effect.

The manufacturing method in the present invention uses the vacuum environment for exciting the photocatalytic material with high purity to the gas or ion phase. Further, it can directly adhere to the surface of the fabric product. The manufacturing method in the present invention, therefore, can avoid the environmental problems (such as water pollution) causing from chemical sputtering, resin coating, impregnated processes. More, it also can obtain the optimum photocatalytic effect.

Other objects, features, and advantages of the present invention will become more fully apparent from the following detailed description of the preferred embodiments, the appended claims, and the accompanying drawings.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims while which are to be accord with the broadest interpretation so as to encompass all such modifications and similar structures.

1. A method for manufacturing the photocatalytic fabric product processing under the vacuum environment, comprising the steps of:
using a plasma process in a fabric product to activate and clean the surface of said fabric product;
using a plasma polymerization process in said fabric product for forming a protective layer on the surface of said fabric product; and
using a sputtering process in said fabric product to make a photocatalytic material excite and form a photoctalytic thin film on said protective layer.

2. The manufacturing method according to claim 1, wherein said vacuum environment is at 10¹˜10⁻⁴ torr.

3. The manufacturing method according to claim 1, wherein said manufacturing method should use inert gas.

4. The manufacturing method according to claim 3, wherein said flow rate of said inert gas should control at 1˜1000 sccm(standard cubic centimeter Per minute, cm3/min).

5. The manufacturing method according to claim 4, wherein said optimum flow rate of said inert gas should control at 20˜100 sccm.

6. The manufacturing method according to claim 1, wherein said processing plasma manufacture should use oxygen and argon gas.

7. The manufacturing method according to claim 6, wherein said flow rate of said oxygen and argon gas should control at 1˜1000 sccm.

8. The manufacturing method according to claim 7, wherein said optimum flow rate of said oxygen and argon gas should control at 20˜10 sccm.

9. The manufacturing method according to claim 1, wherein said processing sputtering process should use argon gas Ar and oxygen.

10. The manufacturing method according to claim 9, wherein said flow rate of said argon gas and oxygen should control at 1˜1000 sccm.

11. The manufacturing method according to claim 10, wherein said optimum flow rate of said argon gas and oxygen should control at 20˜100 sccm.

12. The manufacturing method according to claim 1, wherein said plasma polymerization process should be a continuous plasma polymerization process.

13. The manufacturing method according to claim 1, wherein said sputtering process should be a magnetic sputtering manufacture.

14. A photocatalytic fabric product, mainly comprising;
a fabric product;
a protective layer positioned on the fabric product; and
a photocatalytic thin-film positioned on said protective layer.

15. The photocatalytic fabric product according to claim 14, wherein said protective layer can be formed by silicide.

16. The photocatalytic fabric product according to claim 14, wherein said protective layer can be formed by fluoride.

17. The photocatalytic fabric product according to claim 14, wherein said protective layer can be formed by one of materials from fluorosilicate, fluorosilane, or SiO₂.

18. The photocatalytic fabric product according to claim 14, wherein said photocatalytic thin-film can be chosen from TiO₂, TiO, ZnO, MgO, Al₂O₃, or SiO₂.

19. The photocatalytic fabric product according to claim 14, wherein said thickness of said protective layer can be less than 1 μm.

20. The photocatalytic fabric product according to claim 14, wherein said thickness of said photocatalytic fabric thin-film can be less than 100 nm.
